(19) United States
(12) Patent Application Publication
(10) Pub. No.: US 2018/0366756 A1
(43) Pub. Date: Dec. 20, 2018

(54) MICROBIAL FUEL CELL AND ITS USE

(71) Applicant: Kemira Oyj, Helsinki (FI)

(72) Inventors: Mehrdad Hesampour, Espoo (FI); Hannele Havansi, Espoo (FI); Sakari Halttunen, Espoo (FI); Jussi Ruotsalainen, Espoo (FI); Adina Anghelescu-Hakala, VTT (FI); Jani Pelto, VTT (FI)

(73) Assignee: Kemira Oyj, Helsinki (FI)

(21) Appl. No.: 16/062,964

(22) PCT Filed: Dec. 16, 2016
(86) PCT No.: PCT/FI2016/050883

§ 371 Date: Jun. 15, 2018

(30) Foreign Application Priority Data
Dec. 18, 2015 (FI) 20155971

(51) Int. Cl. H01M 8/16; H01M 8/1053; H01M 8/1009; H01M 2/16; C08L 33/14

(52) U.S. Cl. CPC H01M 8/16; H01M 8/1053; C08L 2203/20; H01M 2/166; C08L 33/14; H01M 8/1009

(57) ABSTRACT

The invention relates to a microbial fuel cell, which comprises a cell reactor, a cathode arranged on a cathode side of the cell reactor, and an anode arranged on an anode side of the cell reactor. The cathode and anode are connected with each other through an external circuit. Further the cell reactor comprises a proton permeable membrane, which is arranged between the anode and cathode, and which divides the cell reactor into the anode side and the cathode side. The membrane comprises a membrane core having a pore size of ≤10 nm and/or divalent rejection ≥50% and a hydrophilic polymeric surface layer on at least one side of the membrane core and attached permanently to the membrane core. The invention relates also to the use of the microbial fuel cell.

The invention relates to a microbial fuel cell and its use according to the preambles of the enclosed independent claims.

Microbial fuel cell (MFC) provides an alternative for energy generation. It offers a possibility to convert chemical energy into electrical energy by using microorganisms. A typical microbial fuel cell comprises a cell reactor with an anode and a cathode, which are connected to each other through an external electrical circuit. On the anode side of cell reactor organic substances in an aqueous liquid medium are oxidized by microorganisms. The oxidation generates carbon dioxide, electrons and protons. Some microorganisms, which are called exoelectrogens, release some of the electrons produced from cell respiration to the anode. The electrons are transferred via the external circuit to the cathode, and the protons are transferred to the cathode through the liquid medium. Electrons and protons are then consumed in chemical reaction(s) at the cathode. For example, in wastewater treatment electrons and protons are consumed at the cathode, combining with oxygen, e.g. from air, and forming water according to the reaction:

O₂+4H⁺+4e⁻→2H₂O

Some of the existing microbial fuel cells comprise membranes that are arranged between the cathode and the anode. The membranes are used in order to prevent the passage of the cations and impurities to the cathode. The membrane may, however, increase the proton transfer resistance from the anode to the cathode.

An object of this invention is to minimise or even eliminate the disadvantages existing in the prior art.

Another object of the present invention is to provide a microbial fuel cell with decreased resistance for electron transfer.

These objects are achieved and the invention is defined by the features disclosed in the independent claims. Some preferable embodiments of the present invention are presented in the dependent claims. The features recited in the dependent claims are freely combinable with each other unless otherwise explicitly stated.

Typical microbial fuel cell according to the present invention comprises

a cell reactor,

a cathode arranged on a cathode side of the cell reactor,

an anode arranged on an anode side of the cell reactor, the cathode and anode being connected with each other through an external circuit, and

a proton permeable membrane, which is arranged between the anode and the cathode, and which divides the cell reactor into the anode side and the cathode side, the membrane comprising a membrane core having a pore size of ≤10 nm and/or divalent rejection ≥50% and a hydrophilic polymeric surface layer on at least one side of the membrane core and attached permanently to the membrane core.

Typically the microbial fuel cell according to present invention is used for treating aqueous liquid medium comprising organic substances.

All the described embodiments and advantages apply both for the microbial fuel cell as well as to the use of microbial fuel cell according to the present invention, when applicable, even if not always explicitly stated so.

Now it has been surprisingly found out that by arranging a proton permeable membrane with a hydrophilic surface layer between the anode and the cathode an enhanced membrane performance can be obtained. It has been observed that the charge transfer resistance of the microbial fuel cell can be reduced in some cases nearly with 90%, which significantly improves the efficiency of the microbial fuel cell.

The proton permeable membrane according to the present invention is arranged between the anode and cathode. The membrane comprises a membrane core, which has a pore size of ≤10 nm and/or divalent rejection value ≥50%. The divalent rejection value is defined as the percentage amount of all divalent ions that are not able to diffuse through the membrane from the anode side to the cathode side. The divalent rejection value is here given as SO₄ or Ca/Mg rejection. Preferably the membrane core has a divalent rejection value of ≥50%, more preferably ≥70%, even more preferably ≥75%. The pore size of the membrane core may be in the range of 0.01-10 nm, preferably in the range of 0.1-10 nm. The membrane core is thus preferably impermeable for organic compounds, as well as ions, especially for di- and multivalent ions.

According to one embodiment of the invention the membrane core is made of synthetic polymer or inorganic material, such as ceramic, carbon, silica or metal or any of their combination. For example, the membrane core may be a ceramic membrane, comprising aluminium oxide, titanium oxide, zirconium oxide and/or silicon carbide. Alternatively the membrane core may be a metal membrane comprising palladium or silver. In general, membrane core made of synthetic polymer provides flexibility for the membrane. On the other hand, membrane core made of inorganic material, such as ceramic, provides robustness, which increases the suitability for use in harsh environments.

According to one preferable embodiment of the invention the membrane core is a semipermeable reverse osmosis (RO) membrane. The reverse osmosis membrane may be made of synthetic polymer. The reverse osmosis membrane may be, for example, a cellulose acetate based membrane or a thin film composite membrane. The thin film composite membrane comprises a selective layer of polyamide or poly(piperazinamide), having a thickness typically ≤1 μm. The reverse osmosis membrane may typically have a divalent ion rejection above 95%.

According to another preferable embodiment of the invention the membrane is a nanofiltration membrane, which has divalent ion rejection ≥50%, preferably ≥70%, more preferably ≥75%. The pore size of the nanofiltration membrane may be in the range of 0.01-10 nm, preferably 0.1-10 nm. The selective layer thickness of the nanofiltration membrane may be ≤1 μm. Nanofiltration membranes may be made from polymeric or inorganic materials. For example, a synthetic polymer such as polyamide or poly(piperazinamide) may be used as membrane material. Alternatively, nanofiltration membranes can be made from inorganic materials, such as aluminium oxides, titanium oxides, zirconia oxides, silicon carbide or any of their combination.

The hydrophilic polymeric surface layer made of synthetic monomers is arranged and attached permanently on at least one side of the membrane core. It is possible to arrange and attach the hydrophilic polymeric surface layer on both sides of the membrane core. Preferably the hydrophilic polymeric surface layer is arranged and attached permanently at least on the anode side of the membrane core.

According to one embodiment of the invention the hydrophilic polymeric surface layer is covalently attached onto the surface of the polymeric membrane core by graft polymerization of suitable synthetic monomers in presence of redox initiator. The surface of the polymeric membrane core may be activated by using suitable chemical treatment, e.g. by simple washing with formaldehyde, whereafter the desired monomers and the redox initiator are brought into contact with the activated surface of the membrane core and the graft polymerization is allowed to proceed until the surface of the membrane core is covered with a unitary continuous layer of the hydrophilic polymer. According to one preferable embodiment the used monomer is 2-acrylamido-2-methylpropane sulfonic acid and the membrane core is a polyamide membrane or a poly(piperazinamide) membrane.

According to one embodiment the hydrophilic polymeric surface layer may be formed from vinylic monomers, such as acrylic acid, itaconic acid, acrylamides, 2-hydroxyethyl methacrylate, which carry reactive groups such as —OH, —COON, —NH₂. These monomers can be polymerised into crosslinked superhydrophilic hydrogels and attached onto the surface of the polymeric membrane core. Furthermore, the hydrophilic polymeric surface layer may comprise synthetic hydrophilic polymer attached to the surface polymeric membrane core by click reactions. Examples of suitable synthetic polymers are end-functionalised polyvinyl alcohols, polyethylene glycols and their crosslinked mixtures.

Metallic or ceramic membrane cores may be coated by using pyrolytic graphite coating. Vapour deposition of graphite provides for formation of thin carbon layers on the membrane core surface. The carbon-coated surfaces of metallic/ceramic membrane core can be covalently functionalized by diazonium chemistry for generation of NH₂ groups which allow irreversible attachment of hydrophilic polymers, as described above.

Alternatively, the covalent functionalisation of the surface of a metallic membrane core is possible through a chemisorption route, which is based on direct metal coordination of relevant functional groups. As an example, the metal-sulphur interactions are suitable for grafting of organosulphuric groups, such as thiols and disulphides.

The thickness of the hydrophilic polymeric surface layer may be ≤1 μm. Preferably the thickness of the hydrophilic layer is smaller than the thickness of the membrane core. In case the hydrophilic surface layer is too thick, the membrane may become too impermeable and increase the internal resistance of the microbial fuel cell.

According to one embodiment the hydrophilic surface layer of the membrane has a water contact angle of 10-50°, preferably 15-25°. The contact angle is measured by forming a droplet of water on the membrane surface.

The membrane may have an oxygen diffusion value of 1×10⁻⁶-6×10⁻⁶ cm²/s.

The membrane may have a water permeability of 0.2-20 U(m²×h×bar).

The membrane is preferably flat and sheet-like.

The microbial fuel cell arrangement comprises at least one anode arranged on the anode side of the cell reactor and at least one cathode arranged on the cathode side of the cell reactor. The anode(s) and the cathode(s) are connected with each other through an external electrical circuit. On the anode side of the cell organic substances in the aqueous liquid phase are oxidized by microorganisms. The oxidation generates carbon dioxide, electrons and protons. The electrons are transferred via the anode and the external circuit to the cathode, and the protons are transferred to the cathode through the membrane. The electrons and protons react with oxygen at the cathode, optionally enhanced by a catalyst, to form water. Anode and/or cathode may comprise a base material onto which one or more layers of different materials may be applied. The base material for anode and cathode may be same or different. According to one embodiment of the invention the anode and/or cathode may thus comprise a mixture of one or more electrically conductive materials, such as metals, carbon or polymers, and optionally also suitable functional materials, such as ion-exchange materials. For example, anode and/or cathode may comprise a base material with high surface area, onto which an electrically conductive layer and optionally a metal catalyst is applied. For example, the anode may be formed as brush, plate, granules, fibrous material, etc. Preferably the cathode comprises at least one catalyst.

According to one preferable embodiment of the invention the cathode is an air cathode, especially when the liquid medium is wastewater from an industrial process or from a municipal waste water treatment process.

The aqueous liquid medium, which is treated by using the microbial fuel cell may be selected from effluents of pulp and paper industry process, oil and gas industry process, or of a mining process, or the liquid medium originates from food or beverage industry, municipal or agricultural waste water.

### EXPERIMENTAL

Some embodiments of the invention are described in the following non-limiting examples.

General Experiment Set-Up and Conditions

Four similar, except for the membrane modification, microbial fuel cell reactors were used in the experiments. Each reactor comprised an anode which was a carbon cloth, a membrane between the anode and cathode, which was a polyamide membrane, as well as a cathode, which was a carbon cloth with catalyst. Anode chamber volume was 25 ml in all examples. Active electrode areas for both anode and cathode were 50 cm². The reactor configuration was flat sheet.

The reference microbial fuel cell and the microbial fuel cells with modified membranes were inoculated at different times. The inoculation lasted 3 days. Microbial fuel cells with modified membranes were operated for 69 and 112 days. Reference microbial fuel cells were operated for 108 and 73 days. All microbial fuel cells were operated at ca. 28 ° C. temperature.

The microbial fuel cells were fed with pre-fermented brewery wastewater

If desired, analysis of soluble COD was performed three times a week for the effluents and once a week for the influents of the microbial fuel cells.

A variable external resistor was connected between the anode and the cathode. Potentials were measured at 10 minute intervals and recorded with the datalogger. The cell voltage and external resistor value were used to calculate power and current. All power production (W/m³) results are expressed in relation to anode chamber volume.

Power Production Results

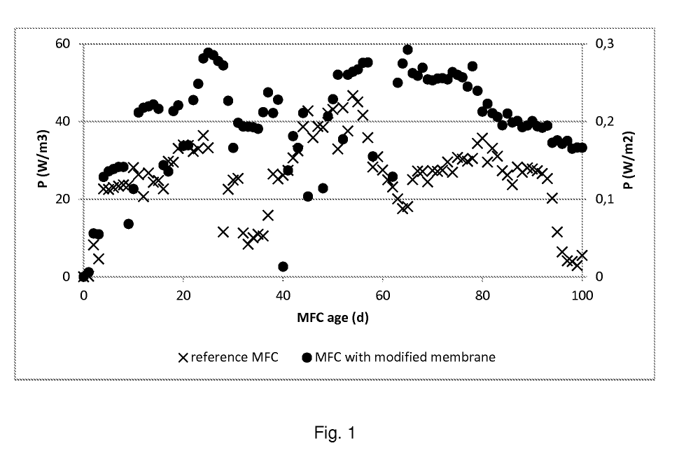

In FIG. 1 the power production of a microbial fuel cell (MFC) reactor with modified membrane is compared with reference microbial fuel cell (MFC) reactor with no modification on membrane. The left axis of FIG. 1 gives the power production per anode volume, W/m³, and the right axis the power production per electrode area, W/m².

Power production of the MFC reactor with modified membrane is depicted with black circles, and power production of the reference MFC reactor is depicted with crosses. As is seen from FIG. 1 the power production of MFC reactor with modified membrane is higher, around +30%, than the power production of the reference MFC reactor. For modified MFC reactor the average of power production is about 40 W/m³ and in some point it reached to 58 W/m³ while for reference MFC reactor the average of power production is about 30 W/m³.

Maximum Power Point Results

Maximum power points (MPP) were obtained by linear sweep voltammetry, LSV, scans for all four microbial fuel cell reactors. The LSV scans were run in two electrode mode, using anode as working electrode. The scans were run individually from open circuit voltage of each cell to 0 mV with 0.5 mV/s scan rate and resulting current was recorded. A summary of these results is presented in Table 1.

TABLE 1
Maximum power point for reference and modified MFC reactors.

| | Number of | | Power of MPP |
|---|---|---|---|
| | LSV scans | | (W/m³) |
| Reference MFC reactors | 17 | Average | 52 |
| | | Max | 95 |
| MFC reactors with modified | 13 | Average | 80 |
| membranes | | Max | 112 |

Charge Transfer Resistance Results

Cell resistances were evaluated using electrochemical impedance spectroscopy, EIS) and equivalent circuit fitting to Randles circuit with Warburg element. The scans were run in two electrode mode, using cathode as working electrode. EIS was run individually for each cell at the approximate voltage of the MPP. Table 2 shows averages of cell resistances for reference MFC reactors and MFC reactors with modified membranes. The charge transfer resistance Rct for MFC reactors with modified membrane is significantly lower, namely 0.3Ω compared to 4.4Ω for reference MFC reactor. This shows that membrane modification has improved electron transfer significantly and consequently improved cell performance, i.e. provided higher power production.

TABLE 2
Cell resistances for reference MFC reactor and MFC reactors with
modified membranes.

| | Number | | | |
|---|---|---|---|---|
| | of EIS | | | W |
| | scans | Rs (Ω) | Rct (Ω) | (1/Ω/sqrt(Hz)) |
| Reference reactors | 13 | 6.5 | 4.4 | 11 |
| Modified reactors | 13 | 5.8 | 0.3 | 9 |

Biofilm Thickness

Fluorescence spectroscopy was performed on surfaces of reactor materials for one reference MFC reactor and for one MFC reactor with modified membrane. Biofilm thickness was measured from three different points in each sample and the average was calculated. The results are presented in Table 3. Note the difference between the biofilm thicknesses of the MFCs on current collector. The increased hydrophilicity of the anode side seems to have attracted more bacteria to live on the most conductive surface.

TABLE 3
Biofilm thickness

| | Reference | MFC with |
|---|---|---|
| | MFC, biofilm | modified membrane, |
| Measurement point | thickness (μm), | biofilm thickness (μm) |
| anode current collector | 25 | 44 |
| carbon cloth anode, water side | 33 | 38 |
| carbon cloth anode, membrane | 15 | 15 |
| side | | |
| membrane, anode side | 13 | not measurable |

Even if the invention was described with reference to what at present seems to be the most practical and preferred embodiments, it is appreciated that the invention shall not be limited to the embodiments described above, but the invention is intended to cover also different modifications and equivalent technical solutions within the scope of the enclosed claims.

1. Microbial fuel cell, which comprises
a cell reactor,
a cathode arranged on a cathode side of the cell reactor,
an anode arranged on an anode side of the cell reactor, the cathode and anode being connected with each other through an external circuit.
a proton permeable membrane, which is arranged between the anode and cathode, and which divides the cell reactor into the anode side and the cathode side, the membrane comprising a membrane core having a pore size of ≤10 nm and/or divalent rejection ≥50% and a hydrophilic polymeric surface layer on at least one side of the membrane core and attached permanently to the membrane core.

2. Microbial fuel cell according to claim 1, wherein the membrane core has a divalent rejection value of ≥50%, more preferably ≥70%, even more preferably ≥75%, and/or the pore size in the range of 0.01-10 nm, preferably in the range of 0.1-10 nm.

3. Microbial fuel cell according to claim 1, wherein the membrane core is made of synthetic polymer; inorganic material, such as ceramic, carbon, silica or metal; or any of their combination.

4. Microbial fuel cell according to claim 1, wherein the membrane core is a reverse osmosis membrane or nanofiltration membrane.

5. Microbial fuel cell according to claim 1, wherein the hydrophilic polymeric surface layer is covalently attached to the surface of the membrane core by graft polymerization of suitable monomers in presence of redox initiator.

6. Microbial fuel cell according to claim 1, wherein the hydrophilic polymeric surface layer is formed from vinylic monomers, which carry reactive groups such as —OH, —COOH, —NH₂.

7. Microbial fuel cell according to claim 5, wherein the monomer is 2-acrylamido-2-methylpropane sulfonic acid and the membrane core is selected from a polyamide membrane, cellulose acetate membrane and poly(piperazinamide).

8. Microbial fuel cell according to claim 1, wherein the hydrophilic polymeric surface layer is attached to the surface of the membrane core through chemisorption.

9. Microbial fuel cell according to claim 1, wherein the thickness of the hydrophilic polymeric surface layer is ≤1 μm.

10. Microbial fuel cell according to claim 1, wherein the membrane has a water contact angle of 10-50°, preferably 15-25°.

11. Microbial fuel cell according to claim 1, wherein the membrane has a water permeability of 0.2-20 L/(m²×h×bar).

12. Use of microbial fuel cell according to claim 1 for treating aqueous liquid medium comprising organic substances.

13. Use according to claim 12, wherein the aqueous liquid medium is selected from effluents of pulp and paper industry process, oil and gas industry process, or of a mining process, or the liquid medium originates from food or beverage industry, municipal or agricultural waste water.
